(19) United States
(12) Patent Application Publication
(10) Pub. No.: US 2008/0008517 A1
(43) Pub. Date: Jan. 10, 2008

(54) Ink-Pen

(75) Inventors: Cheng-Chang Wang, Junghe City (TW); Pai-Hsien Wu, Junghe City (TW)

Correspondence Address: WPAT, PC, 7225 BEVERLY ST., ANNANDALE, VA, 22003, US

(73) Assignee: TA SHIN PRECISION IND. CO., LTD., Junghe City (TW)

(21) Appl. No.: 11/428,811

(22) Filed: Jul. 5, 2006

(51) Int. Cl. B43K 7/12

(52) U.S. Cl. 401/107

(57) ABSTRACT

An improvement of ink-pen is disclosed. The improvement of ink-pen comprises a seal-up element. The seal-up element can protect the lead of the ink-pen effectively and avoid consuming the ink unnecessarily with losing the cover of the ink-pen to extend the lifetime of the improvement of ink-pen.

### BACKGROUND OF THE INVENTION

1. Field of the Invention

The Invention is related to an ink-pen, more particular to an improvement of ink-pen.

2. Description of the Prior Art

Conventionally, a pen cap is used to enclose the pen tip of an ink-pen for protecting the pen tip as well as for preventing the ink from evaporating so as to reduce the ink consumption speed.

Occasionally, the ink-pen is not capped or even the pen cap is lost due to user's personal habit or being forgotten. While the ink-pen is used for the next time, the ink remained in the pen is not sufficient for the writing purpose, which causes inconveniences, such as the needs to suddenly change the writing equipment or to refill the ink-pen. It results in not only the waste of resources but also inconveniences in use. When the conventional ink-pen is carried, the pen cap sometimes will be removed from the ink-pen due to user's body movements. The cloths of the user often get stains from such situations. Therefore, an improved ink-pen is required to resolve the above-mentioned problems for the traditional ink-pen.

### SUMMARY OF THE INVENTION

In light of the above-mentioned background and in order to fulfill the need of the industry, the present invention provides an improvement of ink-pen to resolve the above-mentioned deficiencies of the conventional ink-pen.

One object of the present invention is to provide an improvement of ink-pen, comprising a seal-up element. The improvement of ink-pen can effectively protect a pen core, prevent losing a pen cap, reduce the undesired consumption of ink, and extend the lifetime of the ink-pen.

The present invention provides an improvement of ink-pen, comprising a pen casing, a pen body, a sliding element, a seal-up element and an elastic element so as to be convenient for storage, to reduce ink consumption while in storage, to extend the lifetime. In addition, the improvement of ink-pen prevents cloths from getting stains when the pen cap is accidentally removed so that the user can carry the ink-pen according to the present invention comfortably without fear. Furthermore, in order to improve the writing stability of the improvement of ink-pen according to the invention, the improvement of ink-pen further comprises a plurality of positioning parts to secure the position of the seal-up element and to stabilize the pen body. Besides, in order to further increase the sealing ability to the pen core, the improvement of ink-pen further comprises a plurality of pressurizing elements for increasing the sealing pressure of said seal-up element so as to reinforce the protection to the pen core, reduce the undesired ink consumption, and thereby to extend the lifetime of the ink-pen. The improvement of ink-pen further comprises a pen clip for ease of carrying.

### BRIEF DESCRIPTION OF THE DRAWINGS

FIG. 1 is a structural schematic diagram of the first embodiment of the present invention;

FIG. 2 is a structural schematic diagram of the embodiment of the present invention;

FIG. 3 is a structural schematic diagram of the third embodiment of the present invention; and,

FIG. 4 is an operational schematic diagram of the fourth embodiment of the present invention.

### DESCRIPTION OF THE PREFERRED EMBODIMENTS

What is probed into the invention is an improvement of ink-pen. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

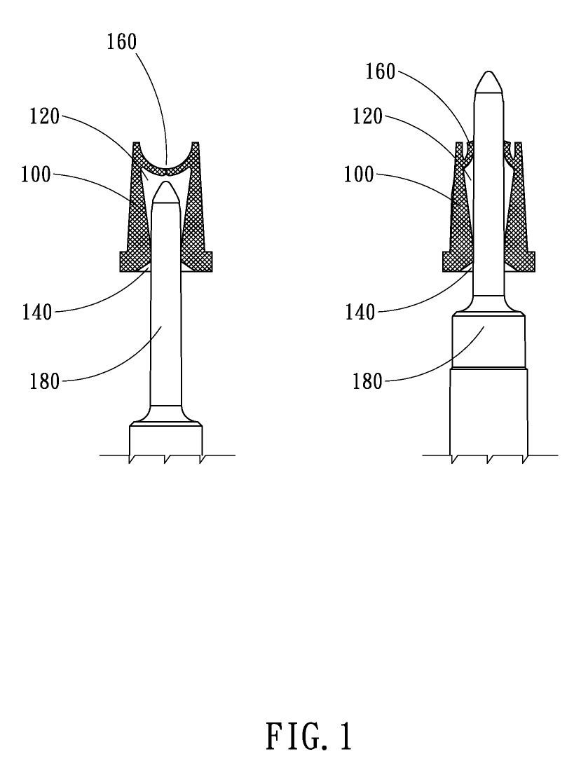

As shown in FIG. 1, the first embodiment of the present invention discloses a seal-up element 100 comprising a cavity 120, a first engaging part 140, and a second engaging part 160. The first engaging part 140 is provided at one end of the cavity 120 while the second engaging part 160 is provided at the other opposite end of the cavity 120. The cavity 120 accommodates a pen core 180. The first engaging part 140 grips and seals the pen core 180. The cavity 120 is sealed by closing up the second engaging part 160 so as to seal the pen core 180 inside the cavity 120. Besides, the pen core 180 can penetrate the second engaging part 160 to extend to the outside of the cavity 120 for writing purpose.

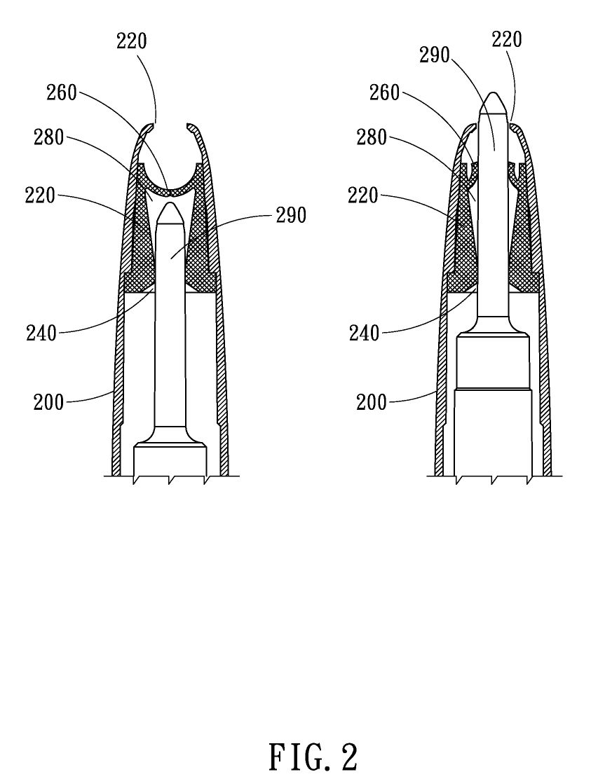

As shown in FIG. 2, the second embodiment of the present invention discloses an improvement of ink-pen, comprising a pen casing 200 and a seal-up element 220. The pen casing 200 includes a first opening 202 provided at one end of the pen casing 200. The seal-up element 220 comprises a first engaging part 240, a second engaging part 260 and a cavity 280. The first engaging part 240 is provided at one end of the cavity 280 while the second engaging part 260 is provided at the other opposite end of the cavity 280. The first engaging part 240 firmly grips and seals a pen core 290 of the ink-pen. The second engaging part 260 is connected with the first opening 202. The cavity 280 is sealed by closing up the second engaging part 260 so as to seal the pen core 290 inside the cavity 280. Besides, the pen core 290 can penetrate the second engaging part 260 to extend to the outside of the pen casing 200.

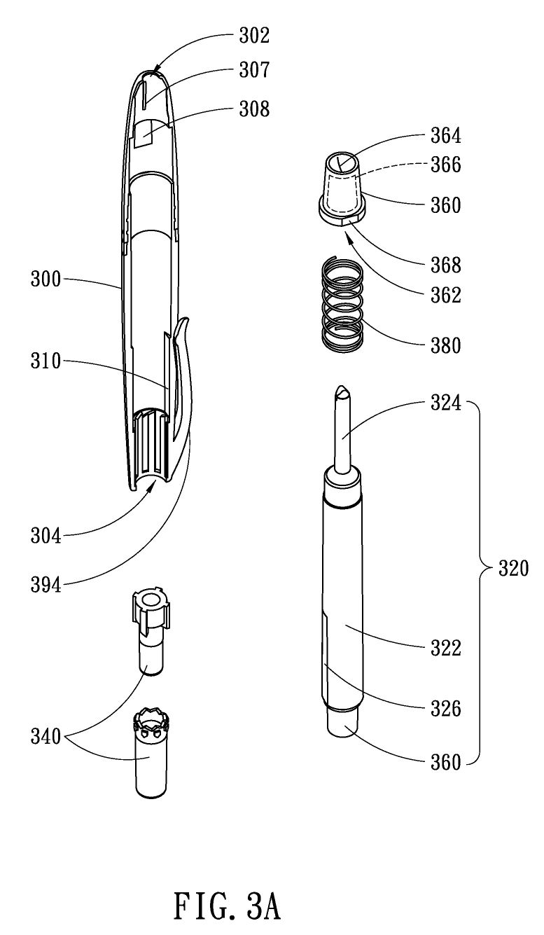

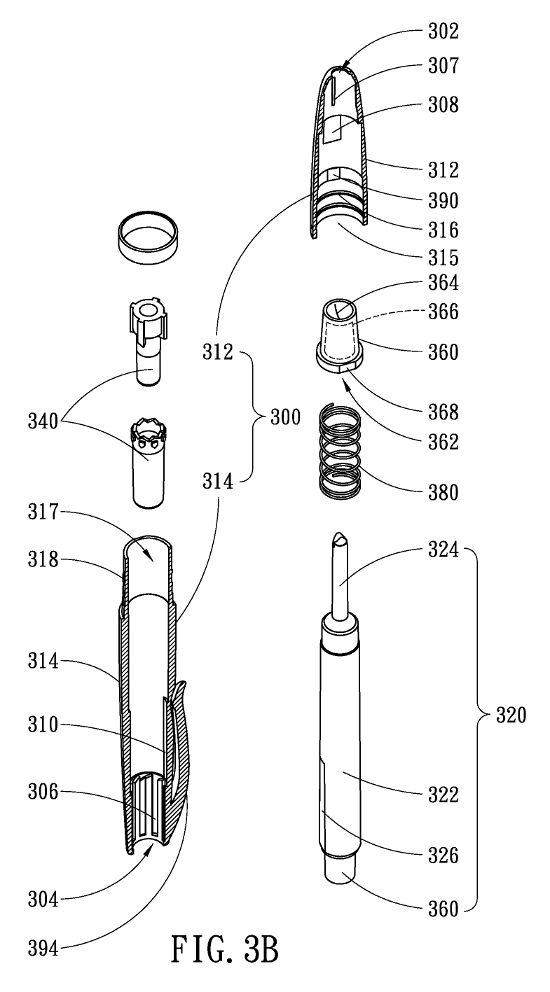

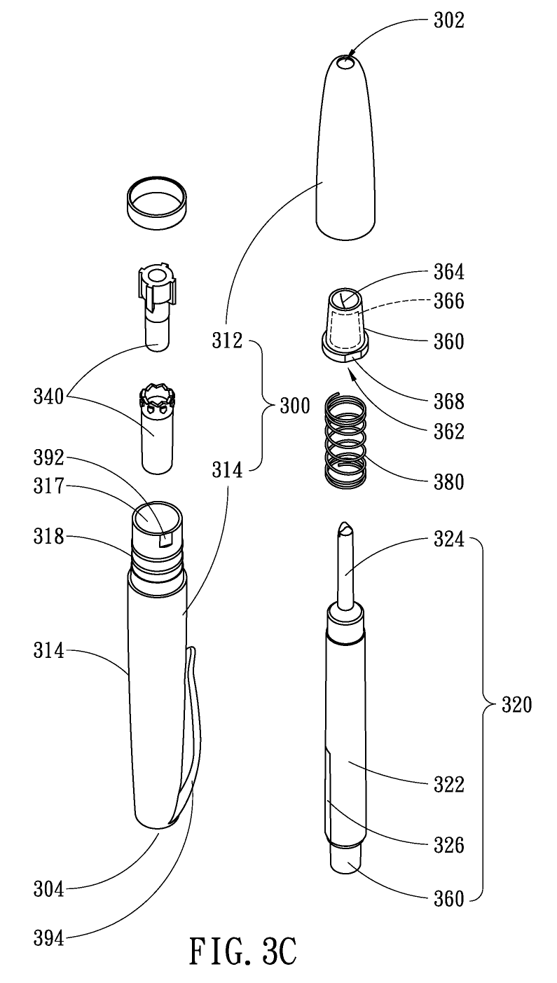

As shown in FIG. 3A, the third embodiment of the present invention discloses an improvement of ink-pen, comprising a pen casing 300, a pen body 320, a sliding element 340, a seal-up element 360, and an elastic element 380.

The pen casing 300 comprises a first opening 302, a second opening 304, and a positioning element 306. The first opening 302 is provided at one end of the pen casing 300 while the second opening 304 is provided at the other opposite end of the pen casing 300. The positioning element 306 is provided at the inner peripheral of the pen casing 300 and connected to the second opening 304.

The pen body 320 is provided inside the pen casing 300. The pen body 320 comprises a pen body part 322 and a pen core 324. The pen core 324 is connected with one end of the pen body part 322. Ink is stored inside the pen body part 322 and is outputted through the pen core 324.

The sliding element 340 is connected to one end of the pen body part 322 while the pen core 324 is connected to the other opposite end of the pen body part 322. The sliding element 340 slides along the second opening 304 to push the pen body 320. The sliding element 340 is fastened with the positioning element 306 to secure the position of the pen body 320.

The seal-up element 360 is provided inside the pen casing 300. The seal-up element 360 comprises a first engaging part 362, a second engaging part 364 and a cavity 366. The first engaging part 362 is provided at one end of the cavity 366 while the second engaging part 364 is provided at the other opposite end of the cavity 366. The first engaging part 362 firmly grips and seals the pen core 324. The second engaging part 364 is connected with the first opening 302. The cavity 366 is sealed by closing up the second engaging part 364 so as to seal the pen core 324 inside the cavity 366. Besides, the pen core 324 can penetrate the second engaging part 364 to extend to the outside of the pen casing 300.

The elastic element 380 is provided inside the pen casing 300. One end of the elastic element 380 is connected with the pen body part 322 while the other end is connected with the seal-up element 360. The sliding element 340 pushes the pen body part 322 to compress the elastic element 380 so that an elastic force can be generated to push back the pen body part 322.

According to this embodiment, as shown in FIG. 3A, the pen casing 300 further comprises a plurality of pressurizing elements 307. The pressurizing elements 307 are provided at the inner peripheral of the pen casing 300 and connected to the first opening 302. The pressurizing elements 307 increase the sealing pressure of the seal-up element 360 and enhance the sealing ability of the seal-up element 360 to the pen core 324. The pen core 324 can be further protected and the undesired ink consumption can be reduced. The lifetime of the improvement of ink-pen is extended.

According to this embodiment, as shown in FIG. 3A, the improvement of ink-pen further comprises a first positioning part 308 and a second positioning part 368. The first positioning par 308 is provided at the inner peripheral of the pen casing 300 and connected with the pressurizing elements 307. The second positioning part 368 is provided at the side of the seal-up element 360. The second positioning part 368 is fastened with the first positioning part 308 to secure the position of the seal-up element 368 and thereby prevent the seal-up element 368 from being shifted.

According to this embodiment of the present invention, as shown in FIG. 3A, the improvement of ink-pen further comprises a third positioning part 310 and a fourth positioning part 326. The third positioning par 310 is provided at the inner peripheral of the pen casing 300 and connected with the positioning element 306. The fourth positioning part 326 is provided at the side of the pen body 322. The fourth positioning part 326 is fastened with the third positioning part 310 to secure the position of the pen body part 322 and thereby prevent the pen body part 322 from rotating in the pen casing 300. Thus, the position of the pen core 324 is secured so that the writing stability is enhanced.

According to this embodiment, as shown in FIG. 3B, the pen casing 300 further comprises an upper pen casing 312 and a lower pen casing 314. The upper pen casing 312 includes a first opening 302, a third opening 315, and a first fastening member 316. The first opening 302 and the third opening 315 are each located at one of the ends of the upper pen casing 312. The first fastening member 316 is connected with the third opening 315. The lower pen casing 314 includes a second opening 304, a fourth opening 317, and a second fastening member 318. The second fastening member 318 is connected with the fourth opening 317. The second fastening member 318 is fastened with the first fastening member 316, in order to connect the upper pen casing 312 with the lower pen casing 314.

According to this embodiment, as shown in FIG. 3C, the improvement of ink-pen further comprises a fifth positioning part 390 and a sixth positioning part 392. The fifth positioning part 390 is connected with the first fastening member 316 while the sixth positioning part 392 is connected with the second fastening member 318. The sixth positioning part 392 is fastened with the fifth positioning part 390 to fix the upper pen casing 312 and the lower pen casing 314.

According to this embodiment, as shown in FIG. 3C, the improvement of ink-pen further comprises a pen clip 394. The pen clip 394 is connected with the pen casing 300 for ease of carrying. The elastic element can be a spring, rubber, sponge or other elastic substance. The seal-up element can be rubber, sponge or any substance with sealing functionality.

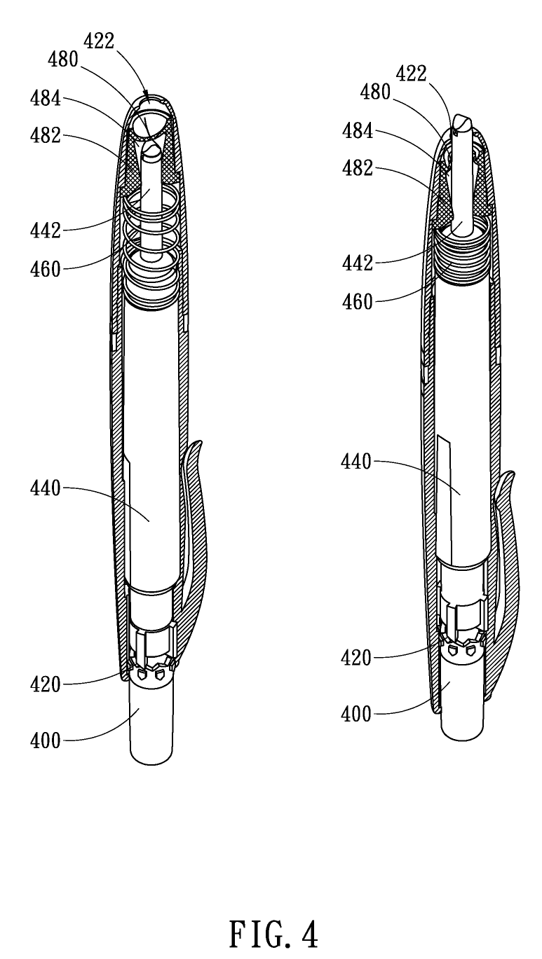

According to the fourth embodiment of the present invention, as shown in FIG. 4, when the sliding element 400 slides in the second opening 420 and thereupon pushes the pen body 440 to thereby compress the elastic element 460, an elastic force is generated and thus the pen core 442 pushes the second engaging part 480 to open the second engaging part 480 so as to let the pen core 442 extend beyond the first opening 422 for writing. When the sliding element 400 retracts from the second opening 420, the elastic force pushes the pen body 440 so that the pen core 442 retracts back into the cavity 484 of the seal-up element 482 for ease of storage, reducing the undesired ink consumption, extending the lifetime of the improvement of ink-pen according to the invention. In addition, the improvement of ink-pen prevents cloths from getting stains when the pen cap is accidentally removed so that the user can carry the ink-pen according to the present invention comfortably without fear.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those who are skilled in the art that many modifications of the present invention may be made without departing from what is intended to be limited solely by the appended claims.

What is claimed is:

1. An improvement of ink-pen comprising:
a pen casing including a first opening, a second opening, and a positioning element wherein said first opening is provided at one end of said pen casing, said second opening at the other end of said pen casing, and said positioning element is provided at the inner peripheral of said pen casing and connected to said second opening;
a pen body provided inside said pen casing wherein said pen body includes a pen body part for storing ink and a pen core connected to one end of said pen body part for outputting said ink;
a sliding element connected to the other end of said pen body part wherein said sliding element is opposing to said pen core with respect to the two ends of said pen body part and is used to push said pen body by sliding in said second opening and besides said sliding element is fastened with said positioning element so as to secure the position of said pen body;
a seal-up element being provided inside said pen casing and comprising a first engaging part, a second engaging part, and a cavity wherein said first engaging part is provided at one end of the cavity for gripping and sealing said pen core, said second engaging part is provided at the other opposite end of said cavity to be connected with said first opening, said cavity is sealed by closing up said second engaging part so as to seal the pen core inside said cavity and the pen core can penetrate said second engaging part to extend to the outside of said pen casing; and
an elastic element provided inside said pen casing wherein one end of said elastic element is connected with said pen body part, the other end of said elastic element is connected with said seal-up element, and thereby said sliding element pushes said pen body part to compress said elastic element to generate an elastic force for pushing back said pen body part.

2. The improvement of ink-pen according to claim 1, wherein said pen casing comprises a plurality of pressurizing elements provided at the inner peripheral of said pen casing and connected with said first opening for increasing the sealing pressure of said seal-up element.

3. The improvement of ink-pen according to claim 1, further comprising:
a first positioning part provided at the inner peripheral of said pen casing and connected with said pressurizing elements; and
a second positioning part provided at one side of said seal-up element for being fastened with said first positioning part to secure the position of said seal-up element.

4. The improvement of ink-pen according to claim 1, further comprising:
a third positioning part provided at the inner peripheral of said pen casing and connected with said positioning element; and
a fourth positioning part provided at one side of said pen body part for being fastened with said third positioning part to secure the position of said pen body part.

5. The improvement of improvement of ink-pen according to claim 1, wherein said pen casing further comprises:
an upper pen casing including a first opening, a third opening, and a first fastening member in which said first opening is provided at one end of said upper pen casing, said third opening is provided at the other end of said upper pen casing, and said first fastening member is connected with said third opening of said upper pen casing; and
a lower pen casing including a second opening, a fourth opening, and a second fastening member in which said second opening is provided at one end of said lower pen casing and said fourth opening is provided at the other end of said lower pen casing, and said second fastening member is connected with said fourth opening of said lower pen casing and is fastened with said first fastening member so as to connect said upper barrel and said lower pen casing together.

6. The improvement of ink-pen according to claim 5, further comprising:
a fifth positioning part connected with said first fastening member; and
a sixth positioning part connected with said second fastening member for being fastened with said fifth positioning part to secure the positions of said upper pen casing and said lower pen casing.

7. The improvement of ink-pen according to claim 1, further comprising a pen clip connected with said pen casing.

8. The improvement of ink-pen according to claim 1, wherein said elastic element is a spring, and the material of said seal-up element is rubber.

9. A seal-up element of an ink-pen, comprising:
a cavity for accommodating a pen core of the ink-pen;
a first engaging part provided at one end of said cavity for gripping and sealing said pen core;
a second engaging part provided at the other opposite end of said cavity; and
wherein said cavity is sealed by closing up said second engaging part so as to seal the pen core inside said cavity and the pen core can penetrate said second engaging part to extend to the outside of said cavity.

10. An improvement of ink-pen comprising:
a pen casing including a first opening provided at one end of said pen casing; and
a seal-up element being provided inside said pen casing and comprising a first engaging part, a second engaging part, and a cavity wherein said first engaging part is provided at one end of the cavity for gripping and sealing a pen core for the ink-pen, said second engaging part is provided at the other opposite end of said cavity to be connected with said first opening, said cavity is sealed by closing up said second engaging part so as to seal the pen core inside said cavity and the pen core can penetrate said second engaging part to extend to the outside of said pen casing.
